(19) United States
(12) Patent Application Publication
(10) Pub. No.: US 2014/0089040 A1
(43) Pub. Date: Mar. 27, 2014

(54) System and Method for Customer Experience Measurement & Management

(71) Applicant: Tata Consultancy Services Limited, Maharashtra (IN)

(72) Inventors: Amresh Nandan, Uttar Pradesh (IN); Rakesh Gunvantray Rathod, Uttar Pradesh (IN); N Sivasamban, New Dehli (IN)

(73) Assignee: Tata Consultancy Services Limited, Maharashtra (IN)

(21) Appl. No.: 14/033,724

(22) Filed: Sep. 23, 2013

(30) Foreign Application Priority Data
Sep. 21, 2012 (IN) 2748/MUM/2012

(51) Int. Cl. G06Q 10/06

(52) U.S. Cl. CPC G06Q 10/0635
USPC 705/7.28

(57) ABSTRACT

The invention measures and captures customer experience perception parameters against a host of touch-points and from various perspectives, through a coordinated and participative process. Further it provides detailed insight into various telecom process and application impacting the customer experience by using standard approach of eTOM process & TAM application for better understand ability. The system also enabled to perform RAG analysis for the purpose of report generation that helps the management identify good/bad customer experience areas within the total lifecycle of the interaction with the customer.

### FIELD OF THE INVENTION

The present invention in general relates to the field of telecommunication. More particularly the invention relates to customer experience measurement and management within the telecommunication industry.

### BACKGROUND OF THE INVENTION

A major challenge with the current technology is that there is no unique way or process of capturing customer experience perception parameters and quantifying them against a standard scale across various mediums and interfaces prevalent in telecom service provider ecosystem. The current systems focus only on system level or operational level performance indicators to analyze the customer experience. At times, unstructured surveys are conducted to gauge customer satisfaction, which is primarily a limited scope and qualitative exercise. Further only a limited set of processes or system KPIs are identified that contribute to customer experience management. This leads to a false impression that the communication service providers (CSP) is performing customer experience management (CEM) tasks.

Customer experience between various interfaces and mediums in a telecom process are not captured in a methodical manner anywhere because of the lack of granularity, uniformity and also lack of mapping between CE factors (KPIs of customer experience) and processes & applications in the telecom operations. Moreover the state of art does not provide any solution that groups numerous customer experience perception parameters across various CSP-Customer interfaces/mediums in telecom service providers' ecosystem and quantifies all the perception parameter across a uniform scale to arrive at a logical decision point of identifying the precise parameters responsible for good or bad customer experience.

Customer perception parameters were traditionally calculated using electronic circuits. However, these type of systems measure customer perception of one service (voice) only and captures quality in telephonic voice connection through small integrated circuit. Further there is no feedback or data collection from users/customer end. Therefore there exists a need of system which identifies perception parameters across customer lifecycle (brand, marketing, product management, service procurement, service delivery, in-service activities) in telecom services providers segment and measures it on uniform scale to compute a total customer experience score.

Methods of documenting the point of pain in current business operation for further improvement through preliminary survey of business capabilities are known in the art. Point of pain here means errors or difficulties in current operation of business system. Thus a need is felt to collect information from plurality of data points and utilize the same for measurement of customer perception for telecom services.

One of the whitepapers of Siddhartha Shankar Ray titled ‘Align Process Metrics to Measure Customer Experience in a Telecom Journey’ elaborates on identifying the right measures and utilizing the Business Process Framework (eTOM) in the telecom journey. However a necessity of measuring customer experience parameter across plurality of mediums/interfaces is identified to be realized on a uniform scale to compute Total Customer experience Score.

In the light of the above mentioned challenges there exists a long-felt need to provide a comprehensive and detailed view of the identified critical processes and applications contributing to good or bad customer experience using RAG analysis within a telecom service lifecycle. The present invention proposes to address the need by mapping the customer experience parameters along with the scores & index to the eTOM processes and TAM standards.

### OBJECTIVES OF THE INVENTION

The principle object of the present invention is to identify plurality of Telecom Processes and applications accountable for variation in customer experience (CE) score.

Another significant object of the invention is to map the customer experience perception parameters to telecom eTOM (processes) & TAM (applications) Standards.

It is another object of the present invention to Identify Telecom process/Application leading to Variation in CE score.

Yet another object of the invention is to classify and highlight telecom process/application in different categories of priority or management attention.

Another object of the invention is to comprehensively measure the customer experience against a host of interfaces and give out a Customer Experience Index (CEI) which indicates the customer's perception for a given CSP.

### SUMMARY

In one of the preferred embodiments of the present invention, a method and system for systematic detection of telecom systems & process responsible for vulnerabilities in telecom service deliveries has been provided. The system broadly comprises of an identification module for retrieving a first vector comprising a plurality of service medium & interfaces, each of the service medium further comprising of a predefined set of customer experience perception parameters in a telecom ecosystem; a systematic analyzer configured for converting plurality of received dynamic customer feedback from plurality of data sources into a database aggregator for bucketing said feedback into at least one pre-identified relevant service medium and interface thereof. The system then computes a total customer experience index depending upon weightage of individual customer experience parameters. The final step involves creating at least one pointer from each identified customer experience perception parameters to at least one recommended element for telecom process and application defined by eTOM processes & TAM standards to be further used for RAG analysis.

The invention measures and captures customer experience perception parameters against a host of interfaces and from various perspectives, through a coordinated and participative process. Further it provides detailed insight into various telecom process and application impacting the customer experience by using standard approach of eTOM process & TAM application for better understand ability. The first vector comprises of experience areas and a plurality of service mediums, each of the service mediums further comprising of a set of interfaces and each of interfaces, further comprising a set of customer experience factors perception parameters in a communication service provider (CSPs) ecosystem; whereas the second vector comprises of a predefined set of recommended elements derived from industry standards for telecom processes & applications.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings example constructions of the invention; however, the invention is not limited to the specific system and method disclosed in the drawings:

FIG. 1 depicts various constituting modules of the Customer Experience Measurement & Management System.

FIG. 2 shows a step by step approach involved for customer experience management planning and execution in accordance with one preferred embodiment of the present invention

FIG. 3 illustrates on the contact point mediums (CPMs) from where plurality of customer inputs is obtained via plurality of data sources in accordance with one preferred embodiment of the present invention.

FIG. 4 represents the broad architectural view of the system and shows the different major modules present in the system.

FIGS. 5(a), (b) and (c) depict the snapshots of the system in accordance for illustrative purposes in accordance with an embodiment of the present invention.

### DETAILED DESCRIPTION OF THE INVENTION

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

The present invention describes a system employing a customer experience measurement and management model that comprehensively measures and captures customer experience perception parameters against a host of CSP-Customer interfaces and from various perspectives, through a coordinated and participative process. Further it provides detailed insight into various Telecom process and application impacting the customer experience by using standard approach of eTOM processes & TAM applications for better understand ability.

A comprehensive approach to measure customer experience of a communication service provider is adopted by deploying a customizable, robust and flexible system. The system broadly comprises of a Customer Measurement Model and a Customer Management Model. While the Customer Measurement Model identifies all key parameters (experience parameter indicator, EPI) impacting a customer experience and measures the customer experience to derive a Customer Experience Index (CEI), the Customer Management Model identifies all key processes and application impacting the Customer Experience Measurement Score. A holistic and standard approach for mapping all parameters to standard eTOM processes and TAM applications is adopted. Further Red-Amber-Green [RAG] analysis is performed for identification of critical processes and application using the score of Contact Point Interfaces (CPIs) from Customer experience measurement framework.

In one aspect, the customer experience measurement model of the system of the present invention performs the following steps. At first, identification of various customer experience perception parameters like Voice quality for VoIP calls, Perceived coverage, Successful Call Completion and the like is performed. Next, the identified perception parameters across various mediums & interfaces are quantified. This quantification is done through two ways depending upon the nature of Customer Experience Factors (CEFs). The CEFs which are directly related to customer's perception are collected through a pre-determined set of feedback mechanism and scaled on a uniform scale of −100 to +100. The CEFs which are relating to system parameters are once again mapped on the scale of −100 to +100 using CSP' strategy for the given experience area and targets of improvement. Further each area (Mediums/interfaces) has a different weightage vis a vis High, Medium, Low, and Not Applicable (H, M, L, NA) which can be varied as per the service provider's strategy and roadmap. Based on the different weight-age for different parameters, the aggregate Customer Experience Index (CEI) is computed.

In one other aspect the customer experience management model focuses on mapping the customer experience perception parameters to Telecom eTOM and TAM Standards. Based on the quantified customer experience parameters mapped to eTOM/TAM, the experience parameters are classified into three different categories. This classification into RED, AMBER & GREEN gives a logical identification of Telecom process/Application leading to variation in CE score.

The invention adopts a holistic approach of first grouping numerous customer experience perception parameters across various CSP-Customer Mediums/Interfaces in telecom service providers ecosystem and quantifying all the perception parameter across a uniform scale to arrive at logical decision points of identifying the contribution of CEFs to the good or bad customer experience of the customers. This measurement part is performed by the customer experience measurement model.

Next, the customer experience management model provides management intelligence by mapping the identified customer experience perception parameters to various applicable Telecom Systems and processes as defined by TM forum. This mapping along with scored experience parameters helps in classification of systems/processes in different categories of priority or management attention. i.e. RED, AMBER, GREEN.

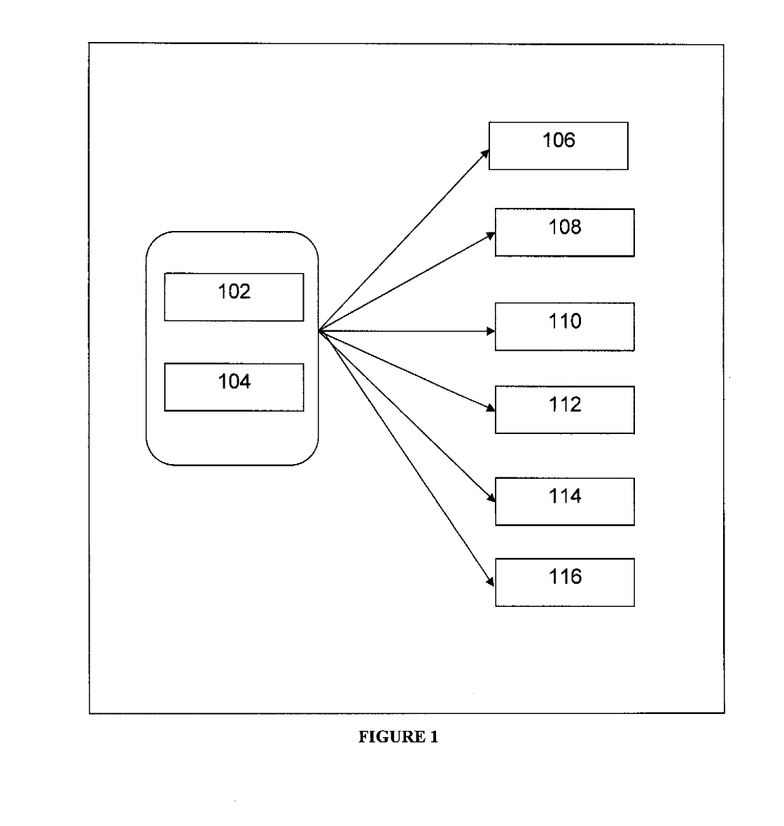

Referring now to FIG. 1, the components involved in the working of the Customer Experience Measurement & Management system 100 are broadly presented.

In one preferred embodiment the system 100 broadly consists of a CE Measurement Toolkit 102, CE Management Toolkit 104, identification module 106, Analyzer module 108, Classifier Module 110, Aggregator 112, Map Module 114, and a Reporting Module 116.

The CE Measurement Toolkit 102 is responsible for deriving Total CE index for CSPs based on their selected customer Interfaces & Mediums.

The CE Management Toolkit 104 is responsible for identifying Parameters & its mapped Applications & Process in Telecom Operations. Maps reporting Good or bad experience provide a basis for management action based on Priorities defined by RAG [Red, Amber, Green] Classification.

The CE Measurement Toolkit further comprises of:

The identification module 106 is responsible for identifying various experience areas, its related services mediums & interfaces which further comprises of various customer perception parameters relevant for Communication Service Providers (CSPs) ecosystem.

The Analyzer Module 108 is responsible for receiving customer feedback against identified customer experience parameters from plurality of data sources into experience factors database.

The Classifier Module 110 is responsible for collating the response available from various feedback sources to the respective experience areas, Services Medium, Interfaces and their related perception parameters.

The aggregator 112 Module is responsible for quantifying the perception parameters across a uniform scale of −100 to 100 and further compute Total Customer Experience Index based on weight-age assigned to various Experience areas, Mediums & Interfaces.

The Customer Management Toolkit further comprises of:

Map module 114 comprising a predefined set of recommended elements derived from industry standards for telecom processes & applications; and mapping them to each service medium & interface parameters to determine a degree of impact on said process & application.

The reporting module 116 is responsible for recommending the parameters & applications mapped to the derived customer experience score for mediums & interfaces as basis of segmentation and bringing details regarding extent to which parameters, applications & process are impacting customer experience to management notice for the purpose of change management and operational implementation.

The system 100, in accordance with an embodiment, may include at least one processor, an input/output (I/O) interface, and a memory. The at least one processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions stored in the memory. The computer-readable instructions may be contained within modules within the memory. The modules may include routines, programs, objects, components, data structures, etc., which perform particular tasks or implement particular abstract data types. The memory may include any computer-readable medium known in the art including, for example, transitory or non-transitory memory, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

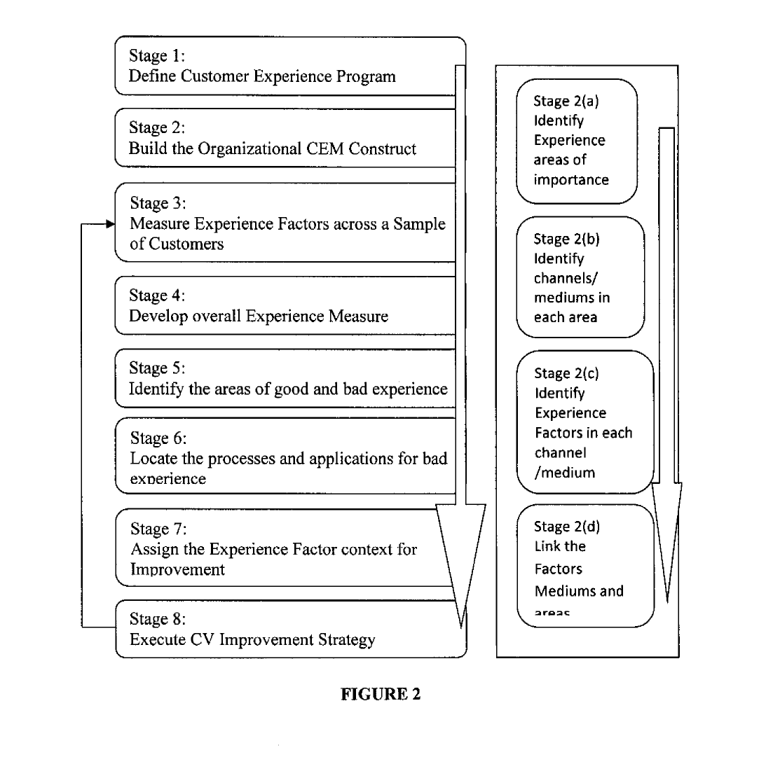

Next, FIG. 2 shows a step by step approach towards customer experience management planning and execution. In stage 1 customer experience programme objectives are defined. Stage 2 further involves four sub steps. While, stage 2a contributes to identification of the customer experience areas and their associated importance, stage 2b involves identification of channels/mediums in each area for which customer experience has been measured. Further stage 2c focuses on identifying experience factors in each channel/medium and lastly stage 2d links the associated factors, mediums and areas. Thus at the completion of stage 2 an architectural construct is obtained for Customer Experience Measurement Toolkit 102.

In the next stage 3 measurements of experience factors is performed for sample customers. Based on the results of stage 3 overall customer experience index is calculated in stage 4. Stage 5 involves identifying the good and bad experience areas based upon the customer experience index obtained in stage 4. Now post identification of good and bad experience (s) of the customer, mapping of these good and bad experience to standards of the telecom industry is performed by the customer experience management model 104 which is elaborated in stage 6. In stage 7 the customer experience index is assigned to the mapped process provides context or reasoning for the variation in CE score. Lastly in stage 8 customer experience improvement strategy is designed and is implemented to increase the overall customer experience in the complete lifecycle.

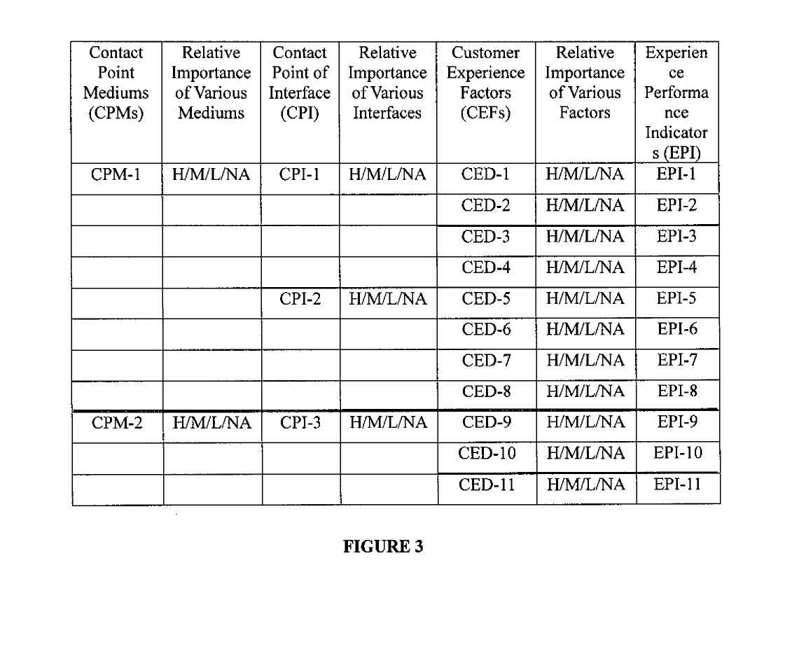

Referring now to FIG. 3, the contact point mediums (CPMs) from where plurality of customer inputs is obtained from different data sources is illustrated. The figure shows categorization of said CPMs according to their level of importance. The levels of importance can be divided as H-high, M-Medium, L-Low and NA—Not applicable. The figure further details of the interface used at the CPM and to derive its relative importance. Based upon the derived importance the customer experience factor (CEF) is calculated. The next step involves categorizing the plurality of CEF's in H/M/L/NA based upon which the experience performance indicator (EPI) is calculated for the identified customer experience parameters.

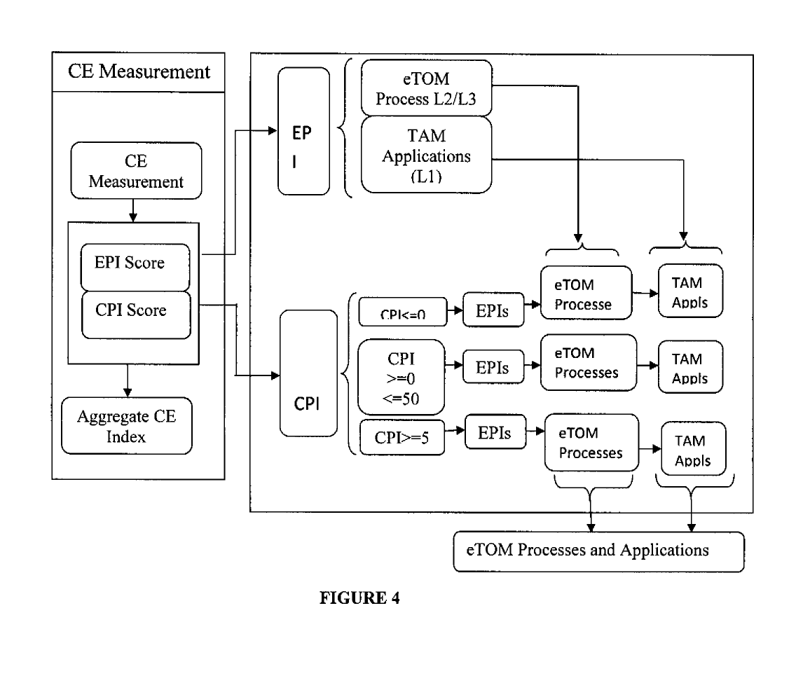

Referring to FIG. 4, the invention can be broadly divided into CE Measurement (102) and CE Management (104) modules. The CE measurement module mainly includes the classifier 110 and the systematic analyzer 112 that work communicatively for quantitative analysis which subsequently leads to generation of EPI and CPI scores.

The aggregator 112, then, is used to generate a total customer experience index based on said scores. By using the EPI score as input the CE management module 104 identifies the eTOM process and TAM applications that lead to undesirable customer experience in the whole cycle. The mapper module 114 of the system is used to assign pointers to the eTOM process and TAM application. In the final stage the reporting module 116 using a RAG analysis in combination with the predefined conditions classifies the eTOM processes and TAM application into Red, Amber and Green. The predefined conditions as shown in Table 1 are used for RAG analysis.

TABLE 1

| | eTOM processes and TAM applications |
|---|---|
| Condition | highlighted using specified color |
| If CPI <= 0 | Red color |
| If CPI >= 0 but CPI < 50 | Amber color |
| If CPI >= 50 | Green Color |

Below Given Table 2 and Table 3 represents examples of the areas, mediums, interfaces and the customers experience parameters. All of these form the basis of the invention.

TABLE 2

| Experience | | | |
|---|---|---|---|
| Area | Medium | Interfaces | Factors/Parameters |
| Retail - | Fixedline | Basic | Timely Provisioning of the |
| Telecom | | Telephony | Fixedline rating by customer |
| Services | | | PSTN Voice quality rating by |
| | | | customer |
| | | | Successful Call Completion |
| | | | rating by customer |
| | | | First Time Call Connect rating |
| | | | by customer |
| | | | Service Disruption Support |
| | | | rating by customer |
| Payment & | Self Care | Bill | Customer Rating for the |
| Transaction - | Portal | Information | availability of information |
| Telecom | | | regarding billed/unbilled |
| Services | | | amount; on the portal. |
| | | | Understandability Rating by |
| | | | customer |
| | | | % of bills adjusted |
| | | | Invoice Look & Feel Rating by |
| | | | customer |
| | | | Invoiced amount according to |
| | | | expectations Rating by customer |

TABLE 3

| Experience | | | |
|---|---|---|---|
| Area | Medium | Interfaces | Factors/Parameters |
| Retail | Mobile | WAP | WAP Connection Speed |
| Telecom | Phone | | Connection Breakage |
| Services | | | WAP Site Loading |
| | | | Ease of Navigation on WAP site |
| | | | Relevance of Information on WAP |
| | | | site |
| | | | Ease of Access |
| | | | WAP site - Look & Feel |
| | | Mobile | Data Services Connection Speed |
| | | Internet/Data | Data Throughput Satisfaction |
| | | Services | Usage Experience - Internet |
| | Data- | Data cards/ | Ease in Installing Dialer Software |
| | card | Dongles | Speed of Connection Set-Up |
| | | | Desired Connection Speed |
| | | | Frequency of Connection Lost |

TABLE 4

| CEF/EPI | Processes/Applications |
|---|---|
| Voice | Processes: |
| quality | 1. [L2] 1.1.2.4 - Service Quality Management |
| for Cellular | 2. [L2] 1.1.3.4 - Resource Performance Management |
| calls | 3. [L2] 1.1.3.5 - Resource Data Collection & Distribution |
| | 4. [L2] 1.1.4.4 - Supplier/Partner Performance Management |
| | Applications: |
| | 1. [L1] 6.9 - Service Quality Management |
| | 2. [L1] 7.9 - Resource Performance Management |
| | 3. [L1] 8.2 - Partner Management |
| Voice | Processes: |
| quality | 1. [L2] 1.1.2.4 - Service Quality Management |
| for VoIP | 2. [L2] 1.1.3.4 - Resource Performance Management |
| calls | 3. [L2] 1.1.3.5 - Resource Data Collection & Distribution |
| | 4. [L2] 1.1.4.4 - Supplier/Partner Performance Management |
| | Applications: |
| | 1. [L1] 6.9 - Service Quality Management |
| | 2. [L1] 7.9 - Resource Performance Management |
| | 3. [L1] 8.2 - Partner Management |
| Perceived | Processes: |
| coverage | 1. [L3] 1.2.1.5.2 - Assess Performance of Existing Products |
| | 2. [L2] 1.1.3.4 - Resource Performance Management |
| | 3. [L2] 1.1.3.5 - Resource Data Collection & Distribution |
| | 4. [L2] 1.1.4.4 - Supplier/Partner Performance Management |
| | Applications: |
| | 1. [L1] 4.4 - Product Performance Management |
| | 2. [L1] 7.9 - Resource Performance Management |
| | 3. [L1] 8.2 - Partner Management |
| Successful | Processes: |
| Call | 1. [L3] 1.2.1.5.2 - Assess Performance of Existing Products |
| Completion | 2. [L2] 1.1.3.4 - Resource Performance Management |
| | 3. [L2] 1.1.3.5 - Resource Data Collection & Distribution |
| | 4. [L2] 1.1.4.4 - Supplier/Partner Performance Management |

As shown in Table 4 the eTOM and TAM applications are listed is post mapping with CE parameters via the mapper component. The table shows experience area as retail services, the medium as mobile phone and the interface as the voice call service on phone.

TABLE 5

| | Experi- | Experi- | Experi- | | TAM |
|---|---|---|---|---|---|
| Experience | ence | ence | ence | eTOM | Apps or |
| Area | Medium | Interface | Parameters | Processes | Modules |
| Interaction | 02 | 05 | 27 | 079 | 160 |
| Retail | 03 | 10 | 43 | 135 | 117 |
| Services | | | | | |
| Enterprise | 06 | 12 | 65 | 212 | 190 |
| Services | | | | | |
| Web/Online | 02 | 05 | 21 | 059 | 067 |
| Store | 02 | 06 | 24 | 073 | 120 |
| Payment & | 04 | 05 | 35 | 072 | 109 |
| Transactions | | | | | |
| Additional | 07 | 08 | 32 | 060 | 113 |
| Services | | | | | |
| TOTAL | 26 | 51 | 247 | 690 | 876 |

Table 5 represents the count of identified Experience Mediums & Interfaces, Experience Parameters, Telecom Standards process and applications mapped to the areas, mediums and interfaces in the Customer Experience Measurement & Management Model.

The foregoing description of specific embodiments of the present invention has been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. The listing of steps within method claims do not imply any particular order to performing the steps, unless explicitly stated in the claim.

### WORKING EXAMPLE

While the model and toolkit has been built with the idea that a CSP should be able to measure and manage customer experience across all mediums and interfaces, across the lifecycle of the customer; for the sake of explanation, a scenario or sample example is elaborated below taking one of the mediums as basis for the example:

Assuming a Scenario, that new CSPs has launched its new website (Company Portal) along with self-care portal and offers data services along with plain vanilla voice services. Here said CSP wants to measure & manage the customer experience for their Retail & Web services. Following steps will be executed as a part of the CEM Toolkit:

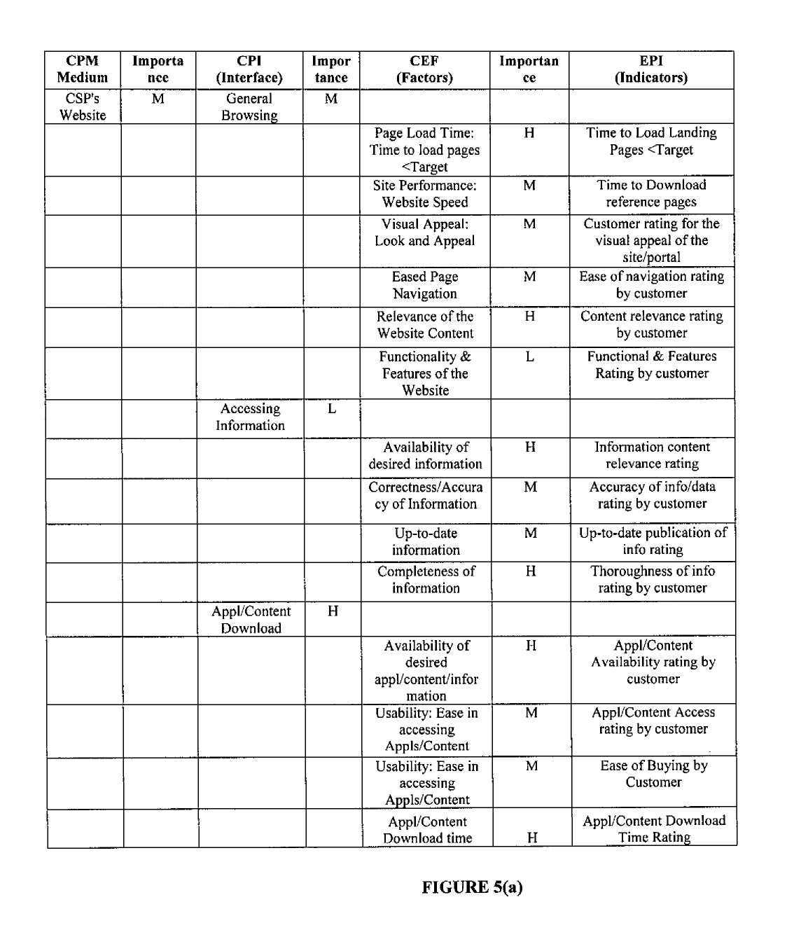

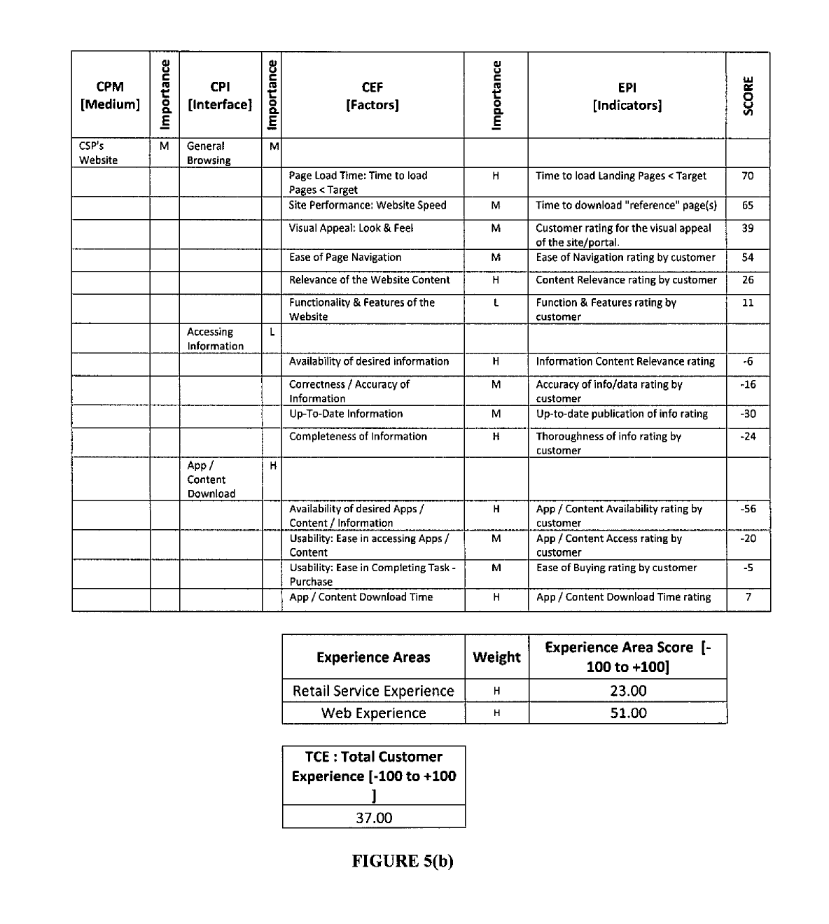

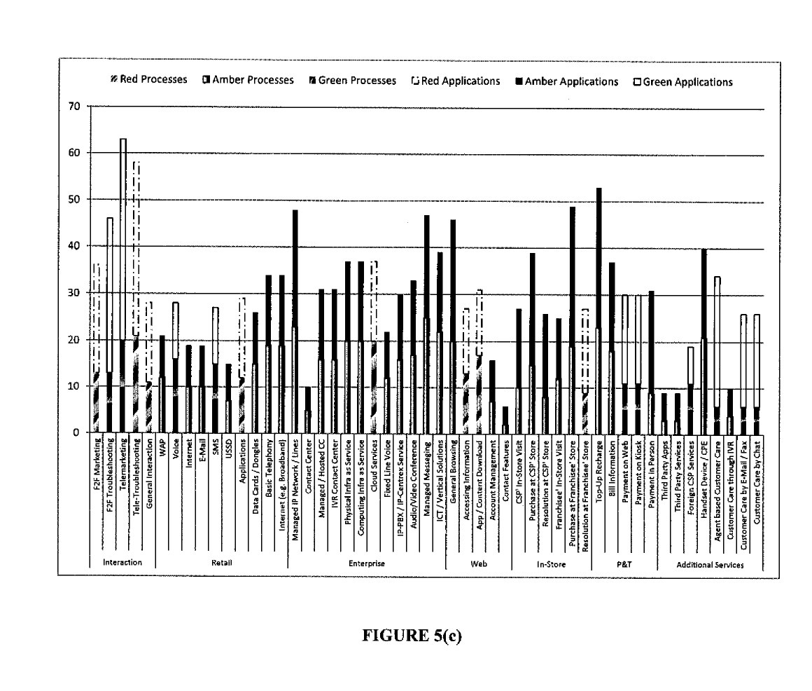

1] Identification of Customer Experience Perception parameters for both the Retail & Web experience area. Sample Snapshot of various perception parameters for Web experience area is shown in FIG. 5(a)
2] Based on various feedback mechanisms, toolkit analyses the response for both customer experience perception parameters as well as the system parameters and co-related them to at least one of the each identified parameters.
3] Further Aggregation process is done for both system level parameters and customer experience perception parameters & they are quantified across a uniform scale to compute & obtain a score for each parameter identified. Snapshot for the same is provided in FIG. 5(b).
4] Mapping all the identified customer experience perception parameters to Standard eTOM processes & TAM applications. Identify critical process and application using the score of EPIs from Customer experience measurement toolkit & categorize them in Red, Amber & Green using RAG analysis.
5] Customer Experience Management reports enable stakeholders within CSPs organization to identify various process and application leading to good or bad experiences based on classification of priorities in which they need to be address to improve the customer experience index for the said CSPs. Snapshots of various reports are provided in FIG. 5(c).

We claim:

1. A method for systematic detection of telecom systems and processes responsible for vulnerabilities in telecom operations and service deliveries, the method comprising:
identifying a first vector having experience areas and a plurality of service mediums, each of the service mediums having a set of interfaces wherein each of the interfaces have a set of customer experience factors perception parameters in a communication service provider (CSPs) ecosystem;
receiving a plurality of dynamic customer feedback from plurality of data sources into at least one experience factors database for at least one identified customer experience factor perception parameters and further conducting a quantitative analysis on at least one feedback to classify said feedback into at least one pre-identified relevant service interfaces and mediums thereof;
quantifying each of the feedbacks and aggregating a quantified numeric value of the received feedback experience factors perception parameters in each of the pre-identified relevant service interfaces to compute a unified total customer experience index;
creating a second vector having a predefined set of recommended elements derived from industry standards for telecom processes & applications;
mapping at least one recommended element in the second vector for the customer experience index of the each service medium & interface parameter to determine a degree of impact on said telecom processes & applications; and
detecting one vulnerable recommended parameter with mapped process & application based on an already derived customer experience score for medium & interfaces as a basis for segmentation to dynamically render status thereof on a coupled display device in a differential color code.

2. The method of claim 1, wherein the first vector includes grouping the set of customer experience perception parameters across various interfaces in communication service providers' ecosystem and further grouping the identified interfaces across mediums in communication service providers, wherein the mediums are clubbed in pre-identified experience areas.

3. The method of claim 1, wherein the second vector having pre-identified perception parameters are mapped one-to-one or one-to-many to eTOM& TAM defined Telecom processes and applications.

4. The method of claim 1, wherein the customer experience factors perception parameters are identified to capture a perception of end-customer utilizing various services rendered by Telecom communication services providers.

5. The method of claim 1, wherein compliance elements are utilized by mapping the customer experience factor perception parameters to Telecom eTOM Standards and mapping the customer experience factor perception parameters to Telecom TAM Standards.

6. A system for dynamic detection of Telecom systems & process responsible for vulnerabilities in telecom service deliveries, the system comprising:
an identification module adapted to retrieve a first vector having a plurality of service medium & interfaces, each of the service medium & interfaces having a predefined set of customer experience perception parameters in a telecom ecosystem;
a systematic analyzer to convert a plurality of received dynamic customer feedback from a plurality of data sources into a database aggregator;
a classifier adapted to bucket said feedback from the plurality of data sources into at least one pre-identified relevant service medium & interface thereof;
an aggregator configured to compute a total customer experience index depending upon weightage of individual parameters;
a mapper configured to insert at least one pointer from each identified customer experience perception parameters to at least one recommended element for telecom process and application defined by eTOM & TAM; and
a reporting module adapted to assign a differential color code based on the pointers and utilizing generated total customer experience index by the aggregator.

7. The system of claim 6, wherein the first vector includes grouping numerous customer experience perception parameters across various interfaces in communication service providers ecosystem and further grouping the identified interfaces across mediums in communication service providers, wherein the mediums are clubbed in pre-identified experience areas.

8. The system of claim 6, wherein the second vector having pre-identified perception parameters is mapped one-to-one or one-to-many to eTOM& TAM defined Telecom processes and applications.

9. The system of claim 6, wherein the customer perception parameters are identified to capture the perception of end-customer utilizing various services rendered by Telecom communication services providers.

10. The system of claim 6, wherein the compliance elements are utilized by mapping the customer experience perception parameters to Telecom eTOM Standards & mapping the customer experience perception parameters to Telecom TAM Standards.
